(19) United States
(12) Patent Application Publication
(10) Pub. No.: US 2004/0253567 A1
(43) Pub. Date: Dec. 16, 2004

(54) Interactive storybook

(76) Inventor: Christopher Kaye, Troy, MI (US)

Correspondence Address: MITCHELL M. MUSIAL II, PLLC, 6960 ABBOTT TERRACE, WEST BLOOMFIELD, MI, 48323, US

(21) Appl. No.: 10/459,764

(22) Filed: Jun. 11, 2003

(51) Int. Cl. G09B 17/00

(52) U.S. Cl. 434/178

(57) ABSTRACT

Disclosed herein is an interactive storybook that is divided into parts that requires a reader to find hidden clues in order to complete the story. The story begins as a traditional book-type story, except when a part is completed, a first clue, which may take the form of a riddle, is provided to direct the reader to the next part. The clue provides the reader with the location of a lock securing a chamber containing a hidden part and how to determine a combination for the lock. In the preferred embodiment, the location of the hidden part is within the covers. At the end of this hidden part is a second clue that tells the reader the location of the lock that secures the chamber, which contains the subsequent part to the story and how to determine a combination of that lock. This sequence continues until the story is complete.

### FIELD OF THE INVENTION

The present invention relates to an interactive storybook that is divided into parts. More specifically, the invention relates to an interactive storybook that requires the reader to find and solve hidden clues to locate additional parts in order to complete the story.

### BACKGROUND OF THE INVENTION

Storybooks have long been a source of entertainment for children and adults alike. Many wonderful stories, fiction and nonfiction, had been disseminated through storybooks. Some storybooks contain a single story, while others may include multiple stories. Although some readers are satisfied with reading a story, others are interested in a more challenging experience. In response, some authors have printed storybooks in multiple parts and even arranged or published the parts out of chronological order.

However, some readers still insist on a more stimulating reading experience, such as that offered by interactivity. To some degree, storybooks have been displaced by electronic media because electronic media is well-suited to provide an interactive environment. As such, electronic media offers an interactive experience that is not provided by storybooks known in the art.

However, electronic media does have a number of shortcomings. Electronic devices are typically much more expensive than a printed storybook. A storybook is easier to transport than electronic media and is less susceptible to damage from temperature extremes and impact than electronic based media. In addition, many people feel printed media is easier to read. Furthermore, storybooks do not have the power demands that electronic media requires.

Therefore, it is desirable to provide an interactive storybook that has the interactive features associated with electronic media and the cost and durability associated with traditional printed storybooks.

### SUMMARY OF THE INVENTION

An interactive storybook comprises a front cover and back cover with a plurality of pages disposed therebetween comprising at least one exposed story part. A plurality of compartments are disposed in at least one of the front cover and back cover. At least one lock is provided for securing at least one compartment. At least one hidden story part is provided. At least one clue is provided within the storybook to provide information for directing a reader toward a hidden story part location and to permit the reader to access a hidden story part.

The hidden story part may be either electronic media, such as a CD-ROM, or written media. As such, the hidden story part may be located outside of the storybook or between the front cover and back cover. The hidden story part may be disposed in at least one of the compartments and furthermore may be comprised of a plurality of pages, scrolls or tablets. The hidden story part may also be encrypted, as well as placed out of chronological order.

The clue may be provided so as to permit a reader to determine a combination to a lock. Furthermore, the clue may take the form of a riddle. Also, the clue may be written so is a solvable from reading a previous story part.

The interactive storybook may include a plurality of hidden story parts and a plurality of clues. At least one of the clues may be disclosed in one of the compartments. Lastly, the clues may be accessed randomly to permit a reader to follow a non-guided story path.

Further objects, features and advantages of the present invention will become apparent to those skilled in the art from analysis of the following written description, the accompanying drawings and the appended claims.

### BRIEF DESCRIPTION OF THE DRAWINGS

FIG. 1 is an illustration of the storybook of the present invention with the front cover open, revealing a story part in a traditional location.

FIG. 2 is a perspective view of the front cover of the storybook of the present invention, revealing a plurality of compartments disposed therein.

FIG. 3 is a perspective view of the back cover of the storybook of the present invention, revealing a plurality of compartments disposed therein.

FIG. 4 is perspective view of the storybook of the present invention, revealing a lock disposed in one of the compartments located in the back cover.

FIG. 5 is perspective view of the storybook of the present invention, revealing a hidden story part disposed in one of the compartments located in the back cover.

### DESCRIPTION OF THE PREFERRED EMBODIMENT

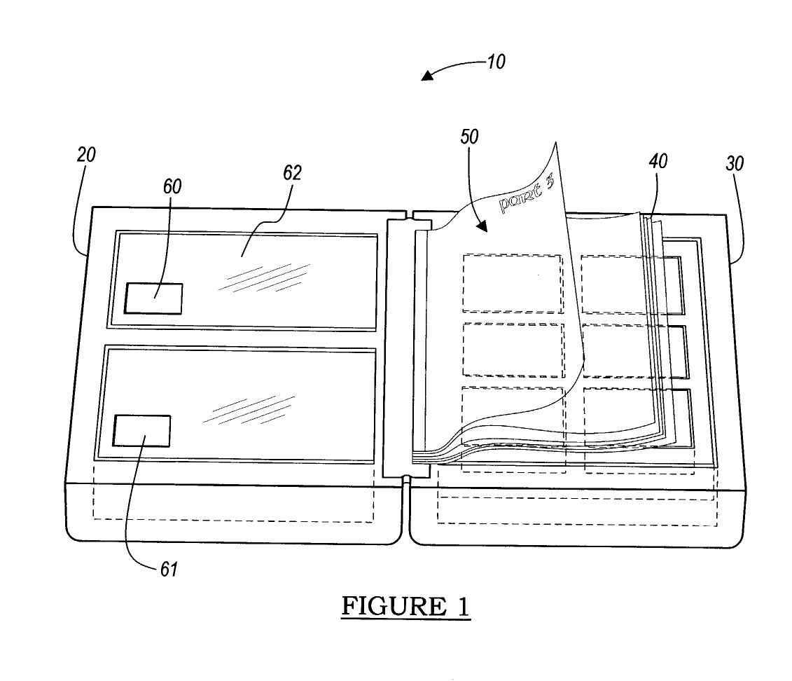

With initial reference to FIG. 1, an illustration of an interactive storybook 10 of the present invention is shown. The interactive storybook 10 as set forth herein requires the reader to find hidden clues or solve riddles in order to complete the storybook 10. The storybook 10 begins as a traditional storybook, except when a part is completed, a clue is provided to direct the reader to the next part. For example, the first clue may be a riddle style clue that provides the reader with the location of a lock, which secures the chamber containing the next story part. The same clue may also provide information to determine a combination for the lock securing the chamber. As used herein, “story part” may be a complete part, a chapter, multiple chapters, a complete story, multiple stories or any fraction or combination thereof.

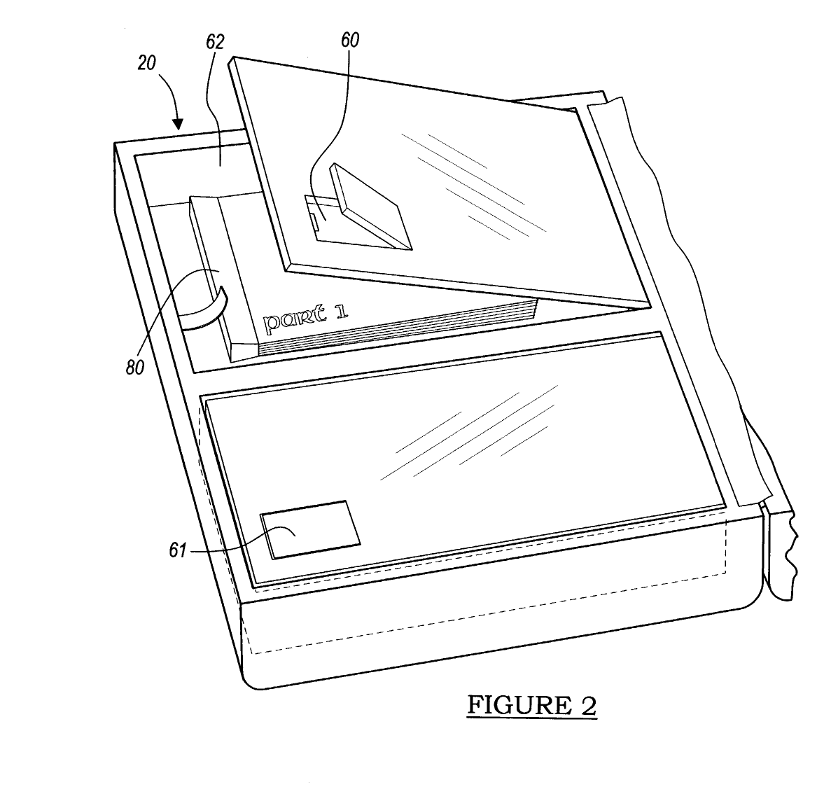

FIG. 1 shows the storybook 10 with front cover 20 opened to reveal a plurality of pages 40 comprising an exposed story part 50, disposed between the front cover 20 and back cover 30. With reference now also to FIG. 2, a perspective view of the front cover 20 is shown, which reveals a plurality of compartments 60, 61, 62 disposed within the front cover 20. Compartments 60 and 62 are shown opened, revealing a hidden story part 80 disposed within compartment 62.

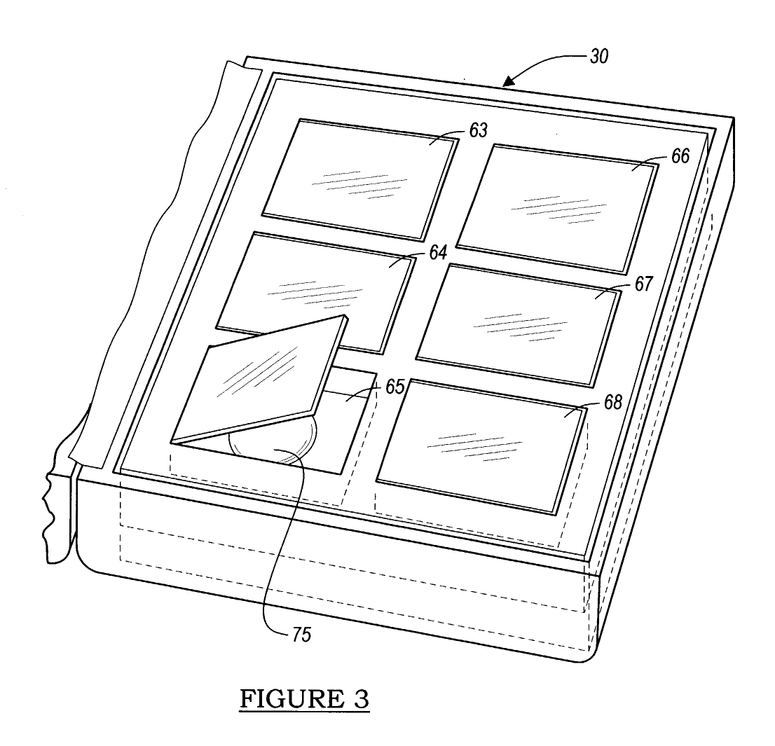

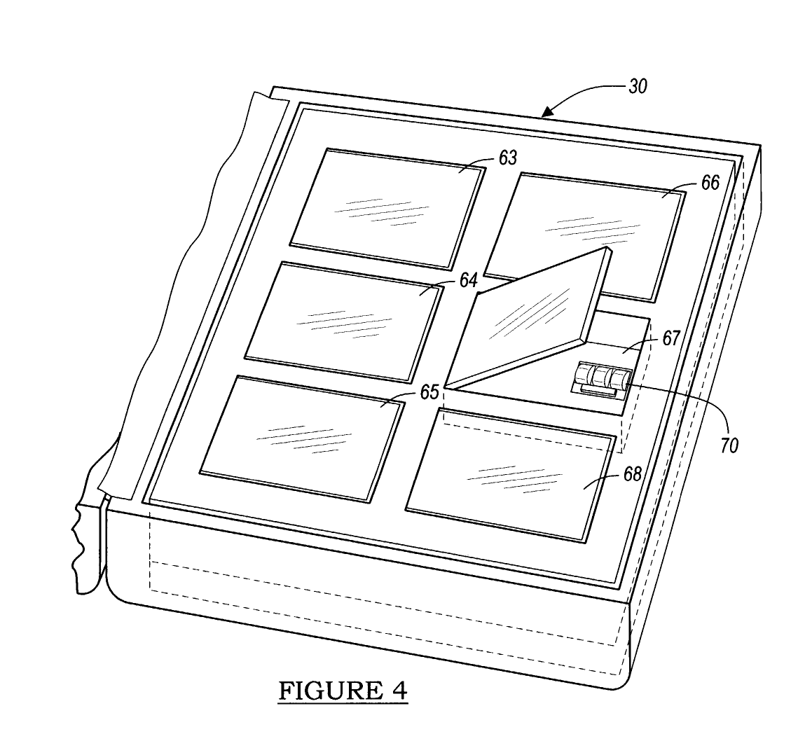

Referring now also to FIG. 3 an illustration of the storybook 10 of the present invention is shown with the back cover 30 opened to reveal a plurality of compartments 63, 64, 65, 66, 67, and 68. Disposed in compartment 65 is a clue 75. It should be noted that although compartments 60-68 are disclosed as located in both the front cover 20 and back cover 30, any suitable number of compartments may be provided and may be disposed only in one of either the front cover 20 or back cover 30. Referring now also to FIG. 4, a lock 70 is shown disposed within compartment 66 in the back cover 30.

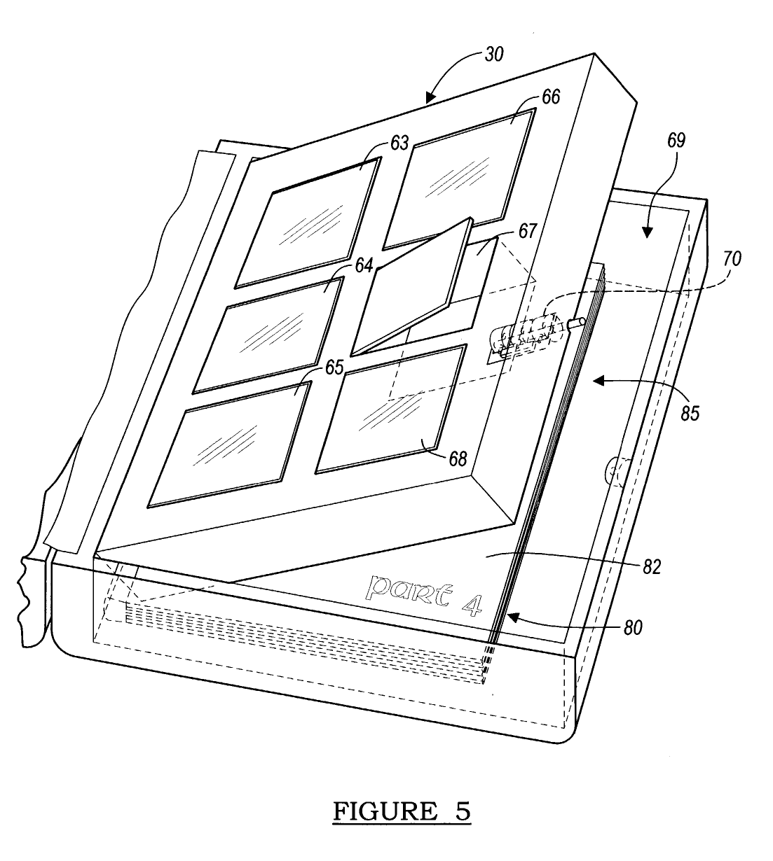

Referring now also to FIG. 5, disposed in the back cover 30 is compartment 69, shown opened to reveal written media 81, which in the present embodiment is a plurality of pages 82, contained therein, comprising a hidden story part 80. In the present embodiment, compartment 69 is a hidden story part location 85.

The present invention is an interactive storybook 10 that that has multiple story parts, including at least one exposed story part 50 and at least one hidden story part 80. It is contemplated that the interactive storybook 10 of the present may have a plurality of hidden story parts 80 as well as a plurality of exposed story parts 50. At least one exposed story part 50 may be removable from the storybook 10. A story part, whether an exposed story part 50 or hidden story part 80, may be written media 81, such as pages 82, scrolls or tablets. Additionally, a story part may take the form of electronic media, such as a CD-ROM. A hidden story part 80 may be located in one of the plurality of compartments 60-69, rendered inaccessible by a lock 70.

Alternatively, a hidden story part 80 may be located between the front cover 20 and back cover 30 or located outside of the storybook 10 in a place such as an Internet web site. A hidden story part 80 may be in open sight, however hidden, because the story part is encrypted requiring a decoding key or initially invisible because it is printed in a glow-in-the-dark or water activated ink, for example.

In order to locate a hidden story part 80, at least one clue 75 must be solved. As used herein, the term “clue” refers to information or objects whereby the reader determines where a story part is located, how to access the story part or both. In the preferred embodiment, a clue in the form of a riddle is printed on paper and disposed at the end of an exposed story part 50 to direct a reader to a hidden story part location 85 and is solvable from information found in a previous story part. However, the clue may be disposed elsewhere within the storybook 10 or outside of the storybook 10. Once solved, the clue provides information to first, direct a reader toward a hidden story part location 85 and second, permit the reader to access the hidden story part 80.

A clue may take several forms, and it is contemplated that a clue may be electronic, including hard media such as a CD-ROM or an Internet based videogame. The clue may also employ off product information, such as, a web page, telephone numbers directing the reader to pertinent messages, cross-references to other products, movies, works of literature and the like. The clue may be a multistage clue, where a first clue provides the reader to another clue, which then leads the reader to a hidden story part location 85. Alternatively, a multistage clue may lead a reader to a hidden story part location 85 where another part of the multistage clue must be solved to access the hidden story part 80.

In the preferred embodiment, at least one hidden story part 80 is rendered inaccessible by a lock 70. A clue located at the end of at least one exposed story part 50 provides the location of the hidden story part 80. As shown FIG. 4, the clue leads a reader to compartment 67 containing a lock 70. The same clue or another clue, when solved, will provide a combination to the lock 70. The lock 70 may be any suitable type known in the art, including numerical, color-coded or keyed, where the location of the key may be subject to a clue, an electronic keypad or a removable locked chamber.

With particular reference now to FIGS. 4 and 5, in the preferred embodiment the hidden story part location 85 is within the back cover 30 of storybook 10. The first clue directs the reader to find color-coded numbers in an unlocked chamber 66 situated in the inside back cover 30 of the storybook 10. These numbers are the combination for the lock 70 that seals the next part's chamber 69, containing hidden story part 80. At the end of hidden story part 80 is a second clue that tells the reader the location of the lock that secures the chamber, which contains the subsequent part to the story and how to determine the combination of the lock. This sequence continues until the story is complete.

Although in the preferred embodiment of the present invention the storybook 10 contains a single story broken into multiple story parts, it is further contemplated that a plurality of stories may be included within the storybook 10. The storyline may follow a guided path, where a clue is located at the end of the first part, which yields the location and combination for a second part. A guided a storyline may be chronological or non-chronological. In other words, a reader may start at part III and then be guided to part IV, and then to Part I and finally to part II, for example. An epilogue to the story may be provided at the end of the last part.

Alternatively, a random path storyline may be provided to the reader, where the reader finds clues as to the location of, and method of accessing, a story part that is random in order. A combination of a guided path and random order path may also be provided where a sufficient number of story parts must be read before clues leading to other story parts may be solved.

Those skilled in the art will realize that additional related materials made provided along with storybook 10, including, but not limited to, a DVD, illustrations, and exposed story parts.

In operation, a reader begins by opening storybook 10 and reads the exposed story part 50. After completing the exposed story part 50, the reader searches for a clue in order to find a first hidden story part 80. The clue, such as a riddle, provides enough information to permit the reader to solve the clue by assembling other information with the information provided in the clue. For example, information from a prior story part may be used to solve the clue.

Once solved, the clue will lead a reader toward a hidden story part location 85. A compartment 67, located at the hidden story part location 85, once opened may reveal a lock 70. The current clue or a new clue provides information to allow a reader to discover a combination to the lock 70. Once the lock 70 is opened, the reader will be able to access the compartment 68, containing the first hidden story part 80.

The hidden story part 80 may be written media 81 such as a scroll. Furthermore, the scroll may be encrypted, requiring the reader to decrypt the scroll in order to be read. A previous clue, a new clue or the current clue may provide the key for decrypting the scroll. After reading the scroll, a reader then begins to search for a clue in order to find a second hidden story part location (not shown). Once the current clue is solved and the second hidden story part location is found, the current clue or a new clue will provide information as to how the reader may access a second hidden story part. The clue may be a key which unlocks a compartment containing the second hidden story part.

After reading the second hidden story part, a reader may search for another clue that directs the reader to a third hidden story part, which may be located off product, such as an Internet web site or any other media source. The next clue may be located off product as well, such as an Internet web site or any other media source. The off product clue may then direct a reader back to the storybook 10 to a second exposed story part (not shown). At the conclusion of the second exposed story part, an epilogue may be found, concluding the story.

The foregoing discussion discloses and describes the preferred structure and control system for the present invention. However, one skilled in the art will readily recognize from such discussion, and from the accompanying drawings and claims, that various changes, modifications and variations can be made therein without departing from the true spirit and fair scope of the invention as defined in the following claims.

What is claimed is:

1. An interactive storybook, comprising:
a front cover and a back cover;
a plurality of pages disposed between said front cover and said back cover, said pages comprising at least one exposed story part;
a plurality of compartments disposed in at least one of said front cover and said back cover;
at least one lock for securing at least one of said plurality of compartments;
at least one hidden story part; and
at least one clue, said clue providing information to: a) direct a reader toward a hidden story part location and b) permit the reader to access said hidden story part.

2. The interactive storybook of claim 1, wherein said at least one hidden story part is selected from the group consisting of electronic media and written media.

3. The interactive storybook of claim 2, wherein at least one said hidden story part is disposed in at least one of said compartments.

4. The interactive storybook of claim 3, wherein said hidden story part is comprised of a plurality of pages.

5. The interactive storybook of claim 1, wherein said clue provides information to permit a reader to determine a combination to said lock.

6. The interactive storybook of claim 1, wherein said hidden story part location is located outside of said book.

7. The interactive storybook of claim 1, wherein said hidden story part is comprised of a plurality of pages disposed between said front cover and said back cover.

8. The interactive storybook of claim 7, wherein said at least one hidden story part is encrypted.

9. The interactive storybook of claim 1, wherein said clue is in the form of a riddle.

10. The interactive storybook of claim 1, wherein said clue is solvable from information provided in a previous story part.

11. The interactive storybook of claim 1, wherein at least one clue is located outside of said book.

12. The interactive storybook of claim 1, wherein said clue is a multistage clue.

13. The interactive storybook of claim 1, wherein said lock is selected from the group consisting of numerical locks, color-coded locks, keyed locks and electronic keypad locks.

14. The interactive storybook of claim 3, wherein at least one of said chambers is locked.

15. An interactive storybook, comprising:
a front cover and a back cover;
a plurality of pages disposed between said front cover and said back cover, said pages comprising at least one exposed story part;
a plurality of compartments disposed in at least one of said front cover and said back cover;
at least one lock for securing at least one of said plurality of compartments;
a plurality of hidden story parts; and
a plurality of clues, said clues providing information to: a) direct a reader toward a hidden story part location and b) permit the reader to access said hidden story part.

16. The interactive storybook of claim 15, wherein at least one of said clues is disposed in one of said compartments.

17. The interactive storybook of claim 15, wherein at least one of said clues directs a reader toward a hidden story part that is not in chronological order.

18. The interactive storybook of claim 15, wherein at least one of said hidden story parts is disposed in at least one of said compartments.

19. The interactive storybook of claim 15, wherein at least one of said hidden story parts is located outside of said book.

20. The interactive storybook of claim 15, wherein said clues are accessed randomly to permit a reader to follow a non-guided story path.

21. The interactive storybook of claim 15, wherein at least one of said clues is located outside of said book.

22. The interactive storybook of claim 15, wherein at least one of said clues is a multistage clue.

23. The interactive storybook of claim 18, wherein at least one of said chambers is locked.
